(19) United States
(12) Patent Application Publication
(10) Pub. No.: US 2015/0130145 A1
(43) Pub. Date: May 14, 2015

(54) WHEEL SUSPENSION FOR VEHICLES

(71) Applicant: Shigeki MIYAMORI, Shizuoka (JP)

(72) Inventor: Shigeki MIYAMORI, Shizuoka (JP)

(21) Appl. No.: 14/541,204

(22) Filed: Nov. 14, 2014

(30) Foreign Application Priority Data
Nov. 14, 2013 (JP) 2013-236073

(51) Int. Cl. B60G 9/02; B60G 7/00; B60G 5/02

(52) U.S. Cl. CPC B60G 9/027; B60G 5/02; B60G 7/00
USPC 280/5.507

(57) ABSTRACT

Herein provided is a suspension assembly that can constantly maintain a frictional force between the ground contact surface of a rear wheel and the road surface when a vehicle goes around a curve. The suspension assembly includes a suspension mechanism and a linkage mechanism. The suspension mechanism is configured to allow a center-of-rotation shaft of the rear wheel to be displaced with respect to a vehicle body in the vertical direction. The linkage mechanism is configured to link the suspension mechanism and the center-of-rotation shaft such that an axis of roll of the vehicle body is constantly located in the vicinity of the contact ground surface and movement of the center-of-rotation shaft with respect to the suspension mechanism is allowed.

### TECHNICAL FIELD

The present invention relates to a suspension assembly for a vehicle including front wheels and rear wheels.

### BACKGROUND ART

As described in “Sports Car; Its Design and Performance” written by Colin Campbell and translated by Yoshiaki Shinoda and Jiro Kashiwagi (page 231, FIGS. 87(a) and 87(b), published Feb. 25, 1971 from Nigensha Co., Ltd.) and “Racing and Sports Car Chassis Design” written by Michael Costin and David Phipps (page 57, FIG. 32, reprinted 1975 from Robert Bentley, Inc.), when a four-wheeled vehicle with equal-length wishbone or independent trailing-arm suspensions such as a common passenger vehicle goes around a curve at a high speed, a centrifugal force acts to significantly tilt a vehicle body about the longitudinal axis of the vehicle body, and to also tilt the neighboring portions to the front and rear wheels and accordingly the wheels themselves with respect to the road surface. When a three-wheeled vehicle (a vehicle in which front wheels or rear wheels can be considered as one wheel) with a prime mover goes around a curve at a high speed, a centrifugal force acts to significantly tilt the “one wheel”.

For heavy trucks with suspensions in which the left and right wheels share an axle (so-called rigid-axle suspensions or deDion-axle suspensions), in contrast, the wheels are not inclined even if the vehicle body is tilted.

### SUMMARY OF INVENTION

### Technical Problem

When the wheels are significantly tilted, an appropriate frictional force may not be maintained between the significantly tilted wheels and the road surface. As a result, the vehicle may become uncontrollable. If the rigid-axle suspensions are used, the ground camber angle of the wheels can be made substantially zero, and therefore contact between the ground contact surface of the wheels or tyre treads and the road surface can be constantly maintained, even at a curve. For example, if this concept is applied to a suspensions 1′ for a rear wheel of a vehicle having one or more front wheels 2′ provided on the front side on both sides in the direction orthogonal to the vehicle centerline CL and having a rear wheel 5′ provided on the rear side along the vehicle centerline, as shown in FIG. 14, the rear wheel 5′ may stand on the edge. Also in FIG. 14, an orthogonal line OL is depicted as an imaginary line orthogonal to the vehicle centerline.

An object of the present invention is to provide a suspension assembly for a vehicle including one or more front wheels provided on the front side on both sides in the direction orthogonal to the vehicle centerline and having one or more rear wheels provided on the rear side along the vehicle centerline, the suspension assembly making it possible to constantly maintain a frictional force between the ground contact surface of the rear wheels and the road surface when the vehicle goes around a curve.

### Solution to Problem

The present invention aims at improving a suspension assembly for a vehicle including one or more front wheels and one or more rear wheels. Defining one side with respect to an orthogonal line orthogonal to a centerline of a vehicle as a front side and the other side with respect to the orthogonal line as a rear side, the one or more front wheels are provided on the front side and located on both sides with respect to the centerline of the vehicle and the one or more rear wheels are provided on the rear side. During normal travel of the vehicle, the front wheels are located in the travel direction of the vehicle in some cases, and the rear wheels are located in the travel direction of the vehicle in other cases. Thus, the front wheels are not always located in the travel direction of the vehicle during normal travel. The rear wheels may be composed of one wheel or double wheels sharing an axle or having a common axle, or may be composed of two wheels not sharing an axle or not having a common axle. The double wheels are disposed proximate to each other enough to be considered to function as a single wheel. In the present invention, the rear wheels may be or may not be driving wheels driven by a prime mover.

In the present invention, the suspension assembly for the one or more rear wheels includes a suspension mechanism and a linkage mechanism. The suspension mechanism is configured to allow a center-of-rotation shaft of the one or more rear wheels to be displaced with respect to a vehicle body in a vertical direction. The linkage mechanism is configured to link the suspension mechanism and the center-of-rotation shaft such that an axis of roll of the vehicle body with respect to the one or more rear wheels is constantly located in the vicinity of a contact ground surface and relative movement of the suspension mechanism with respect to the center-of-rotation shaft is allowed. If the rear wheels are composed of a single wheel or double wheels, the phrase “an axis of roll of vehicle body with respect to the rear wheel(s)” means the axis of tilt of the vehicle body with respect to the single wheel or the double wheels constituting the rear wheels. The term “wheel(s)” refers to a single wheel and a plurality of wheels.

If the rear wheels are composed of two wheels not sharing an axle or not having a common axle, meanwhile, the phrase “an axis of roll of vehicle body with respect to the rear wheel(s)” is defined as follows. First, as a premise for the definition, for each single wheel and not for a combination of the two wheels and the vehicle body as a whole, the suspension mechanism for each wheel and the vehicle body are considered as a single structure. Then, as seen in a coordinate system that is stationary with respect to the wheel, the axis of the track of tilting motion of the structure with respect to the single wheel is defined as “an axis of roll of vehicle body with respect to the rear wheels”. The “an axis of roll of vehicle body with respect to the rear wheels” exists for each of the two wheels (rear wheels).

In addition, the phrase “relative movement of the suspension mechanism with respect to the center-of-rotation shaft” means movement between the suspension mechanism and the center-of-rotation shaft that occurs to maintain the ground camber angle (camber angle) at 0. When the center-of-rotation shaft is immovable with respect to the contact ground surface (road surface), the suspension mechanism moves with respect to the center-of-rotation shaft. When the suspension mechanism is immovable, the center-of-rotation shaft moves with respect to the suspension mechanism.

With the suspension assembly according to the present invention, the suspension mechanism is relatively moved with respect to the center-of-rotation shaft (for example, the suspension mechanism moves with respect to the center-of-rotation shaft with the center-of-rotation shaft extending in parallel with the contact ground surface to tilt the vehicle body) when a centrifugal force acts on the vehicle body at a curve, which makes it possible to keep the rear wheel(s) and the road surface constantly or at all times in contact with each other (in other words, to keep the ground camber angle of the rear wheel(s) substantially zero except for an amount corresponding to deflection).

The axis of roll of the vehicle body is preferably located below the contact ground surface in the vicinity of the contact ground surface (road surface). If the axis of roll of vehicle body is set in this way, the width of variation in angle (camber angle) of the rear wheel(s) with respect to the contact ground surface is reduced even if the weight applied to the rear wheel(s) is varied. This is because a restoring force acts on the rear wheel(s).

In a specific aspect of the present invention, a motor serving as a prime mover is housed inside one of the one or more rear wheels, the motor including a rotor fixed to a wheel member of the one wheel and a stator fixed to the center-of-rotation shaft. Both ends of the center-of-rotation shaft project from a motor case or housing in a horizontal direction. In such as case, if the linkage mechanism includes a pair of mounting members fixed to the both ends of the center-of-rotation shaft, and a pair of movable members configured to swing with respect to the pair of mounting members about the axis of roll of the vehicle body, the present invention can be conveniently implemented if the rear wheels are driving wheels.

In another specific aspect of the present invention, a motor serving as a prime mover is housed inside one of the rear wheel(s), a rotor of the motor is fixed to the wheel member of the one rear wheel, a stator of the motor is fixed to a center-of-rotation shaft of the rear wheel(s), and the stator is provided with a pair of fixed shafts projecting in a lateral direction. The pair of fixed shafts do not necessarily project from the stator in the horizontal direction in parallel with the center-of-rotation shaft, and may extend from the stator in the lateral direction in non-parallel with the center-of-rotation shaft. If the pair of fixed shafts are separately provided from the center-of-rotation shaft, the linkage mechanism may include a pair of mounting members fixed to the fixed shafts, and a pair of movable members configured to swing with respect to the pair of mounting members about the axis of roll of the vehicle body.

In this case, the suspension mechanism preferably includes a pair of arm portions configured to support the pair of movable members, at least one pair of guides each shaped in an arc centered around the axis of roll of the vehicle body and vertically spaced (with a gap provided therebetween), and a pair of rolling mechanisms each including one or more rolling elements configured to roll along the at least one pair of guides. The pair of guides are provided at the mounting members and the pair of rolling mechanisms are held by the movable members. Alternatively, the pair of guides are provided at the movable members and the pair of rolling mechanisms are held by the mounting members. If such a structure including the pair of guides and the one or more rolling elements is employed, the pair of movable members can be smoothly swung about the axis of roll of the vehicle body. Further, alternatively, instead of a pair of guides and a pair of rolling mechanisms, a guide shaped in an arc centered around the axis of roll of the vehicle body and a rolling mechanism including one or more rolling elements configured to roll along the guide may be employed. In this case, the guide is provided at one of the pair of mounting members and the rolling mechanism is held by one of the pair of movable members, or the guide is provided at one of the pair of movable members and the rolling mechanism is held by one of the pair of mounting members.

The suspension assembly preferably further includes an origin return mechanism provided between the mounting members and the movable members and configured to return the movable members to an origin position with respect to the mounting members when the one or more rear wheels are positioned away from the contact ground surface (road surface). If such an origin return mechanism is provided, the rear wheel(s) can be brought into contact with the contact ground surface (road surface) in a stable posture after the rear wheel(s) is moved away from the contact ground surface.

In still another aspect of the present invention, an inner-rotor motor serving as the prime mover is housed between two wheels constituting the double wheels. In this case, both ends of a rotary motor shaft of the motor projects from a motor case or housing in a horizontal direction to be coupled to wheel members of the two rear wheels to constitute the center-of-rotation shaft. The linkage mechanism preferably includes a mounting member provided on the motor housing, and a movable member supported by the suspension mechanism and configured to swing with respect to the mounting member about the axis of roll of the vehicle body. With such a structure, the rear wheels composed of the double wheels can be conveniently used as driving wheels. In this case, the suspension mechanism preferably includes a support frame configured to support the movable member. Preferably, one of the mounting member and the movable member of the linkage mechanism is provided with at least one pair of guides each shaped in an arc centered around the axis of roll of the vehicle body and vertically spaced (with a gap provided therebetween), and the other of mounting member and the movable member holds at least one pair of rolling mechanisms each including one or more rolling elements configured to roll along the at least one pair of guides. If such a structure including the pair of guides and the one or more rolling elements is used, the movable member can be smoothly swung about the axis of roll of the vehicle body even if the rear wheels are composed of double wheels. Alternatively, one of the mounting member and the movable member may be provided with a guide shaped in an arc centered around the axis of roll of the vehicle body, and the other of the mounting member and the movable member may hold a rolling mechanism including one or more rolling elements configured to roll along the guide.

In yet another aspect of the present invention, the vehicle body is provided with a prime mover. In this case, a wheel member of one the one or more rear wheels is fixed to a rotary wheel shaft constituting the center-of-rotation shaft rotationally driven by the prime mover via a transfer mechanism. The linkage mechanism preferably includes a shaft bearing structure configured to rotatably support the rotary shaft, a mounting member in which the shaft bearing structure is housed, and a movable member supported by the suspension mechanism and configured to swing with respect to the mounting member about the axis of roll of the vehicle body. If such a structure is used, the present invention can be conveniently implemented even if the vehicle body is provided with the prime mover.

In this case, the suspension mechanism preferably includes a support frame configured to support the movable member. Preferably, one of the mounting member and the movable member of the linkage mechanism is provided with at least one pair of guides each shared in an arc centered around the axis of roll of the vehicle body and vertically spaced (with a gap provided therebetween), and the other of the mounting member and the movable member holds at least one pair of rolling mechanisms each including one or more rolling elements configured to roll along the at least one pair of guides. With such a configuration, the movable member can be smoothly swung about the axis of roll of the vehicle body even if the vehicle body is provided with the prime mover. Alternatively, one of the mounting member and the movable member may be provided with a guide shaped in an arc centered around the axis of roll of the vehicle body, and the other of the mounting member and the movable member may hold a rolling mechanism including one or more rolling elements configured to roll along the guide.

In this case, the suspension assembly preferably further includes a turning member disposed between the movable member and the support frame to turn over a predetermined angular range on the movable member. If such a turning member is used, the movable member can be securely held in a movable state without interfering with the tilt of the vehicle body caused by motion of the front wheels.

If the rear wheels are composed of two wheels, front-wheel drive may be employed so that the rear wheels are not driven. A prime mover may be disposed in each wheel. Alternatively, driving forces may be individually transferred to the two wheels as with the four-wheel drive.

### BRIEF DESCRIPTION OF DRAWINGS

FIG. 1 is a plan view schematically illustrating a suspension assembly according to a first embodiment of the present invention, which is used to support one rear wheel disposed in the rear of a vehicle body of a vehicle.

FIG. 2 is a front view of the suspension assembly according to the first embodiment of the present invention.

FIG. 3 is a sectional view of FIG. 2 as taken along line III-III.

FIG. 4 illustrates the outline of an essential portion according to a second embodiment.

FIG. 5 is a plan view schematically illustrating a suspension assembly according to a third embodiment of the present invention, which is used to support rear wheels composed of double wheels disposed in the rear of a vehicle body of a vehicle.

FIG. 6 is a sectional view of FIG. 5 as taken along line VI-VI.

FIG. 7 is a sectional view of FIG. 5 as taken along line VII-VII.

FIG. 8 is a plan view schematically illustrating a suspension assembly according to a fourth embodiment of the present invention, which is used to support a rear wheel disposed in the rear of a vehicle body of a vehicle.

FIG. 9 is a sectional view of FIG. 8 as taken along line IX-IX.

FIG. 10 is a sectional view of FIG. 8 as taken along line X-X.

FIG. 11 is a plan view schematically illustrating suspension assemblies according to a fifth embodiment of the present invention, which are used to support two rear wheels disposed in the rear of a vehicle body of a vehicle.

FIG. 12 is a sectional view of FIG. 11 as taken along line XII-XII.

FIG. 13 is a sectional view illustrating the motion of the suspension assemblies when a vehicle runs around a corner.

FIG. 14 illustrates a conventional positional relationship among front wheels, a rear wheel and a suspension assembly in an example vehicle.

### DESCRIPTION OF EMBODIMENTS

Now, some embodiments of a suspension assembly according to the present invention will be described below with reference to the drawings. When one side with respect to an orthogonal line orthogonal to a vehicle centerline is defined as a front side and the other side with respect to the orthogonal line as a rear side, the suspension assembly of the present invention is intended for a vehicle including one or more front wheels provided on the front side of a vehicle body and located on both sides in the direction orthogonal to the vehicle centerline and a rear wheel provided on the rear side of the vehicle body,

### First Embodiment

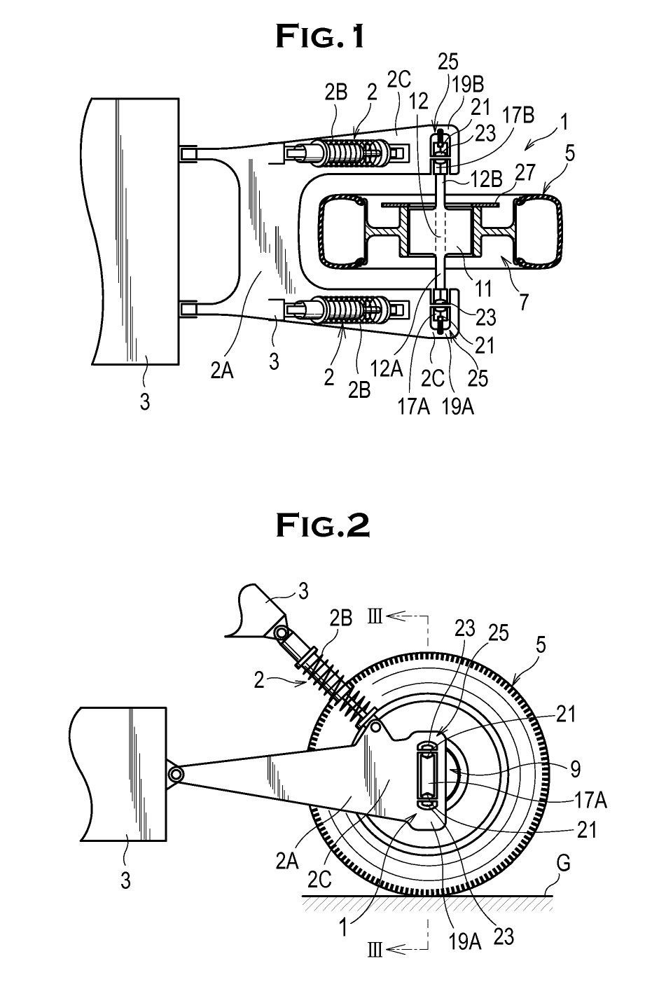

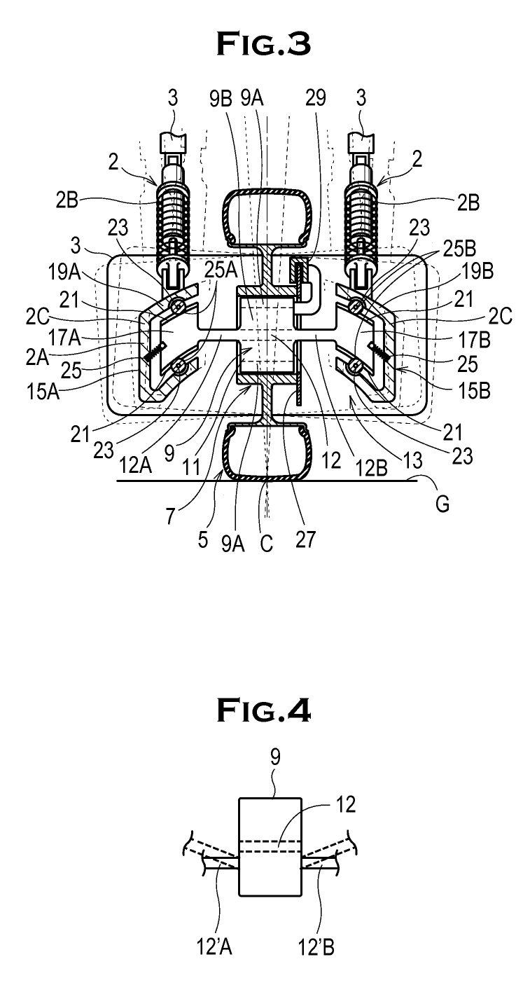

FIGS. 1 and 2 are a plan view and a front view, respectively, schematically illustrating a suspension assembly 1 according to a first embodiment of the present invention wherein the suspension assembly is used to support one rear wheel 5 disposed in the rear of a vehicle body 3 of a vehicle. In FIG. 1, the rear wheel 5 and a wheel member 7 are illustrated in section. FIG. 3 is a sectional view of FIG. 2 as taken along line III-III. In FIGS. 1 and 3, hatching is omitted for better understanding and clarification of the figures in some portions which are supposed to be hatched.

The suspension assembly 1 illustrated in FIGS. 1 to 3 includes a suspension mechanism 2 and a linkage mechanism 13 as discussed later. The suspension mechanism 2 is configured to allow the center-of-rotation shaft of the rear wheel 5 to be displaced with respect to the vehicle body 3 in the vertical direction. The suspension mechanism 2 according to the embodiment is composed of a suspension body 2A and a pair of spring dampers 2B. A first end of the suspension body 2A is rotatably supported by the vehicle body 3. First ends of the pair of spring dampers 2B are rotatably supported by the vehicle body 3. Second ends of the pair of spring dampers 2B are rotatably supported by a portion of the suspension body 2A in the vicinity of a second end thereof. The second end of the suspension body 2A is bifurcated to constitute a pair of arm portions 2C. The second ends of the pair of spring dampers 2B are rotatably coupled to the pair of arm portions 2C. The structure of the pair of arm portions 2C will be described later.

A motor 9 serving as a prime mover is housed inside the wheel member 7 of the rear wheel 5. The motor used in the embodiment is a commercially available in-wheel motor to be built in the rear wheel of an electric motorcycle, for example. A rotor of the motor 9 is fixed to the wheel member 7. A stator of the motor 9 is fixed to a center-of-rotation shaft 12 serving as the center of rotation of the rotor. The stator of the motor 9 is housed in a motor case 11. Both ends 12A and 12B of the center-of-rotation shaft 12 project in the horizontal direction from both side surfaces of the motor case 11 in the axial direction.

As illustrated in FIG. 3, linkage structures 15A and 15B are disposed at the two ends 12A and 12B, respectively, of the center-of-rotation shaft 12. The linkage structures 15A and 15B constitute a linkage mechanism 13. The linkage mechanism 13 links the suspension mechanism 2 and the center-of-rotation shaft 12 such that an axis C of roll of a vehicle body 3 with respect to the rear wheel 5 is constantly or at all times located in the vicinity of the contact ground surface G and movement of the center-of-rotation shaft 12 with respect to the suspension mechanism 2 is allowed. The linkage structures 15A and 15B include mounting members 17A and 17B and movable members 19A and 19B, respectively. The mounting members 17A and 17B are fixed to the two ends 12A and 12B, respectively, of the center-of-rotation shaft 12. The movable members 19A and 19B are configured to swing along the mounting members 17A and 17B, respectively, about the axis C of roll of the vehicle body.

The mounting members 17A and 17B are each provided with a pair of guides 21 each shaped in an arc centered around the axis C of roll of the vehicle body with respect to the rear wheel and vertically spaced (with a gap therebetween in the vertical direction). The movable members 19A and 19B hold a pair of rolling mechanisms 25A and 25B, respectively, each including a pair of rolling elements 23 configured to roll along the pair of guides 21. If such a pair of guides 21 and a pair of rolling mechanisms 25A and 25B including the rolling elements 23 are used, the pair of movable members 19A and 19B can be smoothly swung about the axis C of roll of the vehicle body. As a matter of course, unlike the embodiment, the mounting members 17A and 17B may hold the pair of rolling mechanisms 25A and 25B, respectively, and the movable members 19A and 19B may each be provided with the pair of guides 21 each shaped in an arc centered around the axis C of roll of the vehicle body and vertically spaced (with a gap therebetween in the vertical direction). In theory, one guide and one rolling mechanism will suffice.

A spring member 25 is provided between the mounting member 17A and the movable member 19A and between the mounting member 17B and the movable member 19B. The spring members 25 each constitute an origin return mechanism configured to return the movable member 19A or 19B to the origin position with respect to the mounting member 17A or 17B when the rear wheel 5 is positioned away from the contact ground surface G. The spring members 25 are urged to draw the movable members 19A and 19B toward the mounting members 17A and 17B, respectively. If such spring members 25 (origin return mechanisms) are provided, the rear wheel 5 can be brought into contact with the contact ground surface G again in a stable posture after the rear wheel 5 is moved away from the contact ground surface G.

In the embodiment, a ring-shaped brake disc 27 is fixed to the wheel member 7. The brake disc 27 is provided with a brake pad driving apparatus 29 including a brake pad. The brake pad driving apparatus 29 is fixed to a housing for the motor 9.

In the embodiment, the front wheels (not illustrated) serve as steered wheels. However, the rear wheel 5 may be used as a steered wheel. In the embodiment, the rear wheel serves as a driving wheel. As a matter of course, however, the front wheels (not illustrated) may be used as driving wheels.

According to the embodiment, when a centrifugal force acts on the vehicle body 3 while the vehicle is traveling around a curve, the linkage mechanism (15A and 15B) which links the suspension mechanism 2 of the suspension assembly 1 for the rear wheel 5 and the center-of-rotation shaft 12 allows motion of the suspension mechanism 2 and the center-of-rotation shaft 12 to maintain the ground camber angle (camber angle) at 0. Specifically, the rolling elements 23 move along the pair of guides 21, and the pair of movable members 19A and 19B are smoothly swung about the axis C of roll of the vehicle body with respect to the rear wheel 5. As a result, the center-of-rotation shaft 12 is not moved with respect to the contact ground surface G, but the suspension mechanism 2 is moved with respect to the center-of-rotation shaft 12 to tilt the vehicle body 3. Thus, the rear wheel 5 and the road surface are kept in contact with each other constantly or at all times. In the embodiment, the axis C of roll of the vehicle body is located below the contact ground surface G in the vicinity of the contact ground surface G. Thus, the width of variation in angle (camber angle) of the rear wheel 5 with respect to the contact ground surface G is reduced even if the weight applied to the rear wheel 5 is varied.

### Second Embodiment

FIG. 4 illustrates the outline of an essential portion of a suspension assembly according to a second embodiment of the present invention, which is a modification of the first embodiment illustrated in FIGS. 1 to 3. In the embodiment, as illustrated in FIG. 4 and as in the first embodiment, the motor 9 serving as a prime mover is housed inside the rear wheel, the rotor of the motor 9 is fixed to the wheel member, and the stator of the motor 9 is fixed to the center-of-rotation shaft 12. The stator is provided a pair of fixed shafts 12′A and 12′B configured to project in the horizontal direction from the stator in parallel with the center-of-rotation shaft 12. As indicated in FIG. 4 by broken lines, the pair of fixed shafts 12′A and 12′B may be provided on the stator to project in the lateral direction in non-parallel with the center-of-rotation shaft 12. The pair of mounting members 17A and 17B included in the linkage structures 15A and 15B of the linkage mechanism 13 discussed above are fixed to the pair of fixed shafts 12′A and 12′B, respectively. The embodiment is otherwise the same in configuration as the first embodiment. The suspension assembly according to the present invention can also be implemented by using the fixed shafts 12′A and 12′B which are different from the center-of-rotation shaft as in the embodiment. Also in this case, as in the first embodiment, the mounting members 17A and 17B are each provided with a pair of guides 21 each shaped in an arc centered around the axis C of roll of the vehicle body with respect to the rear wheel and vertically spaced (with a gap therebetween in the vertical direction). The movable members 19A and 19B hold a pair of rolling mechanisms 25A and 25B, respectively, each including a pair of rolling elements 23 configured to roll along the pair of guides 21. Alternatively, as a matter of course, the mounting members 17A and 17B may hold the pair of rolling mechanisms 25A and 25B, respectively, and the movable members 19A and 19B may each be provided with the pair of guides 21 each shaped in an arc centered around the axis C of roll of the vehicle body and vertically spaced (with a gap therebetween in the vertical direction). Also in this case, in theory, one guide and one rolling mechanism will suffice.

### Third Embodiment

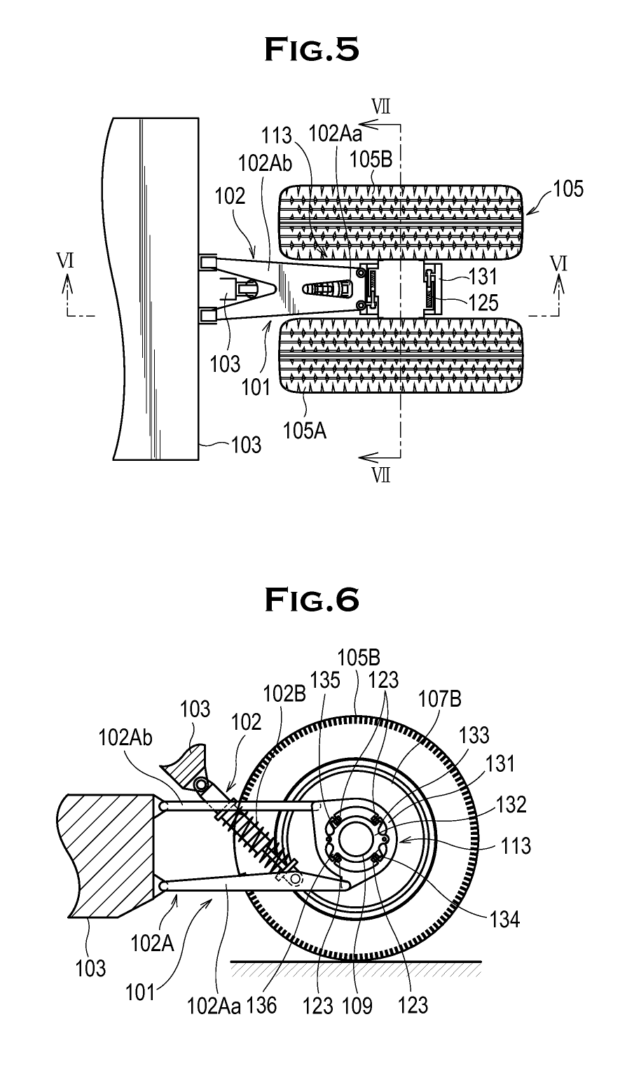

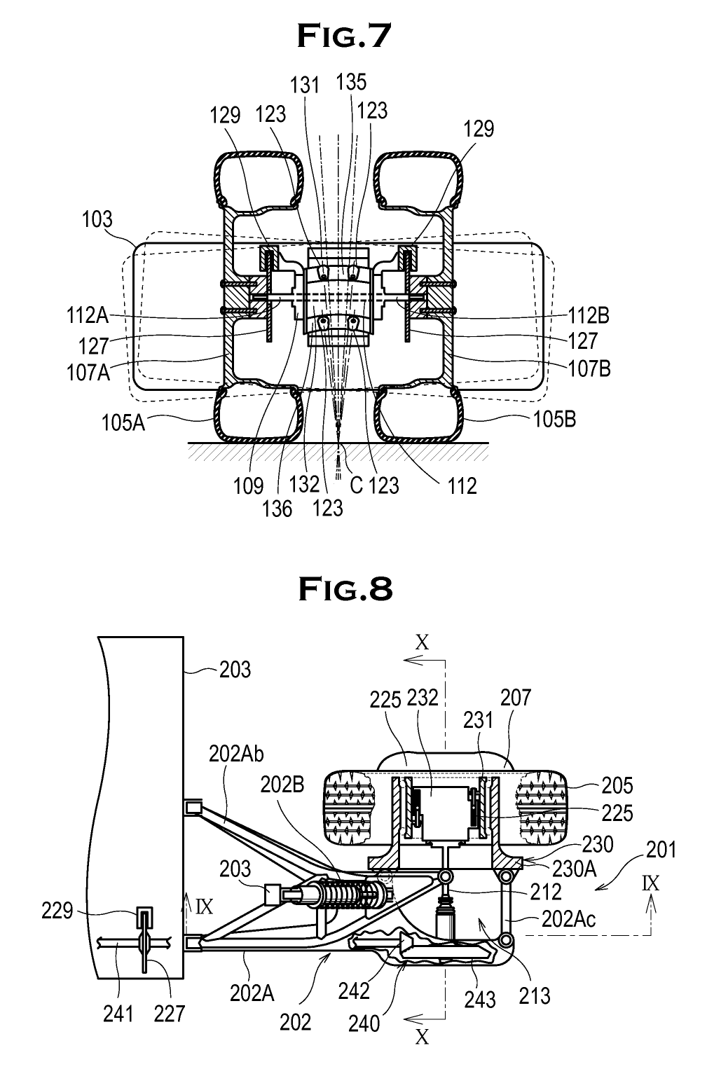

FIG. 5 is a plan view schematically illustrating a suspension assembly 101 according to a third embodiment of the present invention, which is used to support rear wheels 105 composed of double wheels 105A and 105B disposed in the rear of a vehicle body 103 of a vehicle. FIG. 6 is a sectional view of FIG. 5 as taken along line VI-VI. FIG. 7 is a sectional view of FIG. 5 as taken along line VII-VII. In FIGS. 6 and 7, hatching is omitted for better understanding and clarification of the figures in some portions which are supposed to be hatched. In FIGS. 5 to 7, parts similar to the parts constituting the first embodiment illustrated in FIGS. 1 to 3 are denoted by reference numerals obtained by adding 100 to the reference numerals affixed to their counterparts in FIGS. 1 to 3.

In the third embodiment illustrated in FIGS. 5 to 7, an inner-rotor motor 109 serving as a prime mover is disposed between the wheels 105A and 105B constituting the rear wheels 105. In this case, both ends of a rotary motor shaft of the motor 109 projects from a motor housing in the horizontal direction to be coupled to wheel members 107A and 107B of the double wheels 105A and 105B, respectively, to constitute a center-of-rotation shaft 112. The suspension assembly 101 includes a suspension mechanism 102 and a linkage mechanism 113 as discussed later. The suspension mechanism 102 is configured to allow the center-of-rotation shaft 112 of the rear wheels 105 to be displaced with respect to the vehicle body 103 in the vertical direction.

In the embodiment, a brake disc 127 is fixed to each of both ends 112A and 112B of the center-of-rotation shaft 112. The brake disc 127 is provided with a brake pad driving apparatus 129 including a brake pad. The brake pad driving apparatus 129 is fixed to a housing for the motor 109. In the embodiment, the front wheels (not illustrated) serve as steered wheels. However, the rear wheels 105 may be used as steered wheels. In the embodiment, the rear wheels serve as driving wheels. As a matter of course, however, the front wheels (not illustrated) may be used as driving wheels.

The suspension mechanism 102 according to the embodiment is composed of a suspension body 102A including first and second links 102Aa and 102Ab, and a spring damper 102B. First ends of the first and second links 102Aa and 102Ab are rotatably supported by the vehicle body 103. A first end of the spring damper 102B is rotatably supported by the vehicle body 103. A second end of the spring damper 102B is rotatably supported by a portion of the first link 102Aa of the suspension body 102A in the vicinity of a second end thereof. Second ends of the first and second links 102Aa and 102Ab are rotatably attached to an outer cylindrical member 131 constituting a movable member, at locations spaced from each other in the vertical direction. An inner cylindrical member 132 is disposed inside the outer cylindrical member 131. The inner cylindrical member 132 is separately formed from the outer cylindrical member 131, and constitutes a mounting member to be fitted to a housing for the motor 109. In addition, eight rolling elements 123 constituting a rolling mechanism are rotatably mounted to the outer cylindrical member 131. Four guide wall portions (guides) 133 to 136 are integrally provided on the outer peripheral surface of the inner cylindrical member 132. The guide wall portions 133 to 136 extend in the radially outward direction and the axial direction of the center-of-rotation shaft 112. Two guide wall portions 133 and 134 are paired, and two guide wall portions 135 and 136 are paired. As illustrated in FIG. 7, the guide wall portions 133 to 136 each have an arcuate shape formed about the axis C of roll of the vehicle body. In the embodiment, the rolling elements 123 are rotatably mounted to the inner wall portion of the outer cylindrical member 131 such that two rolling elements 123 roll on each guide wall portion. In the embodiment, as a result, when a centrifugal force acts on the vehicle body 103 while the vehicle is traveling around a curve, the linkage mechanism (131, 132, and 133 to 136) which links the suspension mechanism 102 for the rear wheels 105 constituting the double wheels 105A and 105B and the center-of-rotation shaft 112 allows motion of the suspension mechanism 2 and the center-of-rotation shaft 112 to maintain the ground camber angle (camber angle) at 0. Specifically, the rolling elements 123 move along the guide wall portions 133 to 136, and the outer cylindrical member 131 is smoothly swung about the axis C of roll of the vehicle body. As a result, the center-of-rotation shaft 112 is not moved with respect to the contact ground surface G, but the suspension mechanism 102 is moved with respect to the center-of-rotation shaft 112 to tilt the vehicle body 103. Thus, the double wheels 105A and 105B and the road surface are kept in contact with each other constantly or at all times. In the embodiment, the axis C of roll of the vehicle body is located below the contact ground surface G in the vicinity of the contact ground surface G. Thus, the width of variation in angle (camber angle) of the double wheels 105A and 105B with respect to the contact ground surface G is reduced even if the weight applied to the double wheels 105A and 105B is varied.

In the embodiment, the rear wheels 105 composed of the double wheels 105A and 105B can be conveniently used as driving wheels. Although the first and second links 102Aa and 102Ab constitute a support frame configured to support the outer cylindrical member 131 serving as a movable member in the suspension mechanism 102, the structure of the support frame is not specifically limited. Also in the embodiment, one of the inner cylindrical member 132 and the outer cylindrical member 131 constituting the mounting member and the movable member, respectively, of the linkage mechanism may be provided with at least one pair of guide wall portions (133 to 136) each shaped in an arc centered around the axis C of roll of the vehicle body and vertically spaced (with a gap therebetween in the vertical direction), and the other of the inner cylindrical member 132 and the outer cylindrical member 131 may hold at least one pair of rolling mechanisms each including one or more rolling elements 123 configured to roll along the at least one pair of guide wall portions (133 to 136). If such a structure including the pair of guide wall portions and the one or more rolling elements 123 is used, the movable member can be smoothly swung about the axis C of roll of the vehicle body even if the rear wheels 105 are composed of double wheels. Alternatively, one of the outer cylindrical member 131 and the inner cylindrical member 132 may be provided with a guide wall portion (guide) shaped in an arc centered around the axis C of roll of the vehicle body, and the other of the outer cylindrical member 131 and the inner cylindrical member 132 may hold a rolling mechanism including one or more rolling elements configured to roll along the guide wall portion.

### Fourth Embodiment

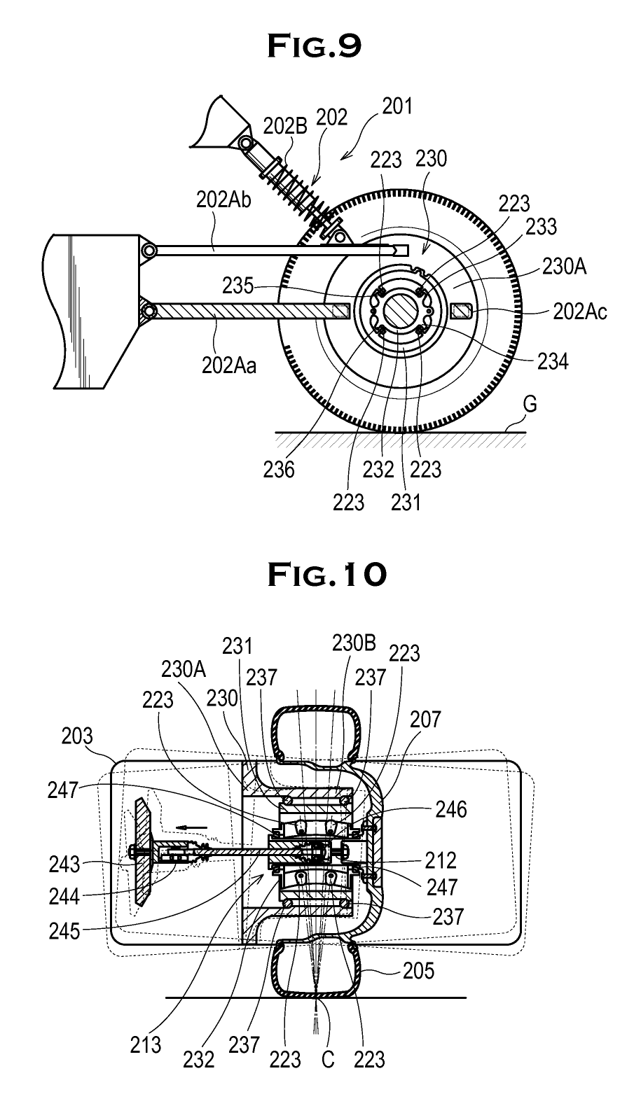

FIG. 8 is a plan view schematically illustrating a suspension assembly 201 according to a fourth embodiment of the present invention which is used to support a rear wheel 205 disposed in the rear of a vehicle body 203 of a vehicle. FIG. 9 is a sectional view of FIG. 8 as taken along line IX-IX. FIG. 10 is a sectional view of FIG. 8 as taken along line X-X. In FIGS. 8 to 10, hatching is omitted for better understanding and clarification of the figures in some portions which are supposed to be hatched. In FIGS. 8 to 10, parts similar to the parts constituting the first embodiment illustrated in FIGS. 1 to 3 are denoted by reference numerals obtained by adding 200 to the reference numerals affixed to their counterparts in FIGS. 1 to 3.

The suspension assembly 201 according to the embodiment includes a suspension mechanism 202 and a linkage mechanism 213. The suspension mechanism 202 is configured to allow a center-of-rotation shaft 212 of the rear wheel 205 to be displaced with respect to the vehicle body 203 in the vertical direction. The linkage mechanism 213 links the suspension mechanism 202 and the center-of-rotation shaft 212 such that an axis C of roll of vehicle body of the vehicle body 203 with respect to the rear wheel 205 is located in the vicinity of the contact ground surface G constantly or at all times and relative movement of the suspension mechanism 202 with respect to the center-of-rotation shaft 212 is allowed.

In the fourth embodiment illustrated in FIGS. 8 to 10, the vehicle body 203 is provided with a prime mover (such as an engine). In the embodiment, a wheel member 207 of the rear wheel 205 is fixed to a rotary wheel shaft constituting the center-of-rotation shaft 212 rotationally driven by the prime mover via a transfer mechanism 240 (241 to 246). The linkage mechanism 213 includes a shaft bearing structure 247, an inner cylindrical member 232, and a movable member (230, 231). The shaft bearing structure 247 rotatably supports the rotary wheel shaft. The inner cylindrical member 232 constitutes a mounting member in which the shaft bearing structure 247 is housed. The movable member (230, 231) is supported by the suspension mechanism 202, and configured to swing with respect to the inner cylindrical member 232 constituting the mounting member about the axis C of roll of the vehicle body.

The transfer mechanism 240 includes a drive shaft 241, a first bevel gear 242, a second bevel gear 243, a first coupling mechanism 244, and a second coupling mechanism 246. The drive shaft 241 is rotationally driven by a prime mover (not illustrated). The first bevel gear 242 is provided at the distal end of the drive shaft 241. The second bevel gear 243 is meshed with the first bevel gear 242 to transfer rotation in the direction orthogonal to the drive shaft 241. The first coupling mechanism 244 transmits rotation of the second bevel gear 243 to a transfer shaft 245. The second coupling mechanism 246 couples the transfer shaft 245 and the center-of-rotation shaft 212 to each other. The first coupling mechanism 244 is configured to transfer rotation from the second bevel gear 243 to the transfer shaft 245 while causing slip between the second bevel gear 243 and the transfer shaft 245 when the second bevel gear 243 is swung. Meanwhile, the second coupling mechanism 246 is configured to transfer rotation while swinging the transfer shaft 245 with respect to the center-of-rotation shaft 212. A Birfield constant-velocity joint, for example, may be used as the second coupling mechanism 246. The center-of-rotation shaft 212 fixed to the wheel member 207 is rotatably supported by the shaft bearing structure 247 fixed to the inner cylindrical member 232 constituting a fixing member.

The suspension mechanism 202 according to the embodiment is composed of a suspension body 202A including first and second links 202Aa and 202Ab and a third link 202Ac, and a spring damper 202B. First ends of the first and second links 202Aa and 202Ab are rotatably supported by the vehicle body 203. A first end of the spring damper 202B is rotatably supported by the vehicle body 203. A second end of the spring damper 202B is rotatably supported by a portion of the second link 202Ab of the suspension body 202A in the vicinity of a second end thereof. Second ends of the first and second links 202Aa and 202Ab are rotatably coupled to a flange portion 230A of a cylindrical body 230. An outer cylindrical member 231 is rotatably fitted to the cylindrical body 230. The cylindrical body 230 and the outer cylindrical member 231 constitute a movable member. A first end of the third link 202Ac is rotatably mounted to the distal end portion of the first link 201Aa. A second end of the third link 202Ac is rotatably mounted to the flange portion 230A of the cylindrical body 230.

In the cylindrical body 230, the outer cylindrical member 231 is provided via bearings 237 in a cylindrical portion 230B located inside the wheel member 207. The inner cylindrical member 232 is disposed inside the outer cylindrical member 231. The inner cylindrical member 232 is separately formed from the outer cylindrical member 231, and constitutes a mounting member. In addition, eight rolling elements 223 constituting a rolling mechanism are rotatably mounted to the outer cylindrical member 231. Four guide wall portions (guides) 233 to 236 are integrally provided on the outer peripheral surface of the inner cylindrical member 232. The guide wall portions 233 to 236 extend in the radially outward direction and the axial direction of the center-of-rotation shaft 212. Two guide wall portions 233 and 234 are paired, and two guide wall portions 235 and 236 are paired. As illustrated in FIG. 10, the guide wall portions 233 to 236 have an arcuate shape formed about the axis C of roll of the vehicle body. In the embodiment, the rolling elements 223 are rotatably mounted to the inner wall portion of the outer cylindrical member 231 such that two rolling elements 223 roll on each guide wall portion. In the embodiment, as a result, when a centrifugal force acts on the vehicle body 203 while the vehicle is traveling around a curve, the linkage mechanism 213 (223 and 230 to 237) which links the suspension mechanism 202 for the rear wheel 205 and the center-of-rotation shaft 212 allows motion of the suspension mechanism 202 and the center-of-rotation shaft 212 to maintain the ground camber angle (camber angle) at 0. Specifically, the rolling elements 223 move along the guide wall portions 233 to 236, and the outer cylindrical member 231 is smoothly swung about the axis C of roll of the vehicle body. As a result, the center-of-rotation shaft 212 is not moved with respect to the contact ground surface G, but the suspension mechanism 202 is moved with respect to the center-of-rotation shaft 212 to tilt the vehicle body 203. Thus, the rear wheel 205 and the road surface are kept in contact with each other constantly or at all times. In the embodiment, the axis C of roll of the vehicle body is located below the contact ground surface G in the vicinity of the contact ground surface G. Thus, the width of variation in angle (camber angle) of the rear wheel 205 with respect to the contact ground surface G is reduced even if the weight applied to the rear wheel 205 is varied. The bearings 237 provided between the cylindrical body 230 and the outer cylindrical member 231 allow the suspension mechanism 202 to be swung in the vertical direction with respect to the outer cylindrical member 231. In the embodiment, as illustrated in FIG. 8, a spring member 225 is disposed between the outer cylindrical member 231 and the inner cylindrical member 232 as an origin return mechanism. The spring member 225 is urged to return the outer cylindrical member 231 to the origin when the rear wheel 205 is lifted.

Although the first to third links 202Aa to 202Ac constitute a support frame configured to support the cylindrical body 230 in which a movable member is housed in the suspension mechanism 202 in the embodiment, the structure of the support frame is not specifically limited. Also in the embodiment, one of the inner cylindrical member 232 and the outer cylindrical member 231 constituting the mounting member and the movable member, respectively, of the linkage mechanism may be provided with at least one pair of guide wall portions (233 to 236) each shaped in an arc centered around the axis C of roll of the vehicle body and vertically spaced (with a gap therebetween in the vertical direction), and the other of the inner cylindrical member 232 and the outer cylindrical member 231 may hold at least one pair of rolling mechanisms each including one or more rolling elements 223 configured to roll along the at least one pair of guide wall portions (233 to 236). If such a structure including the pair of guide wall portions and the one or more rolling elements 223 is used, the movable member (230, 231) can be smoothly swung about the axis of roll of the vehicle body. Alternatively, one of the outer cylindrical member 231 and the inner cylindrical member 232 may be provided with a guide wall portion (guide) shaped in an arc centered around the axis C of the vehicle body, and the other of the outer cylindrical member 231 and the inner cylindrical member 232 may hold a rolling mechanism including one or more rolling elements configured to roll along the guide wall portion.

In the embodiment, as shown in FIG. 8, a brake disc 227 is fixed to the drive shaft 241. The brake disc 227 is provided with a brake pad driving apparatus 229 including a brake pad. The brake pad driving apparatus 229 is fixed to the vehicle body 203. In the embodiment, the front wheels (not illustrated) serve as steered wheels. However, the rear wheel 105 may be used as a steered wheel.

### Fifth Embodiment

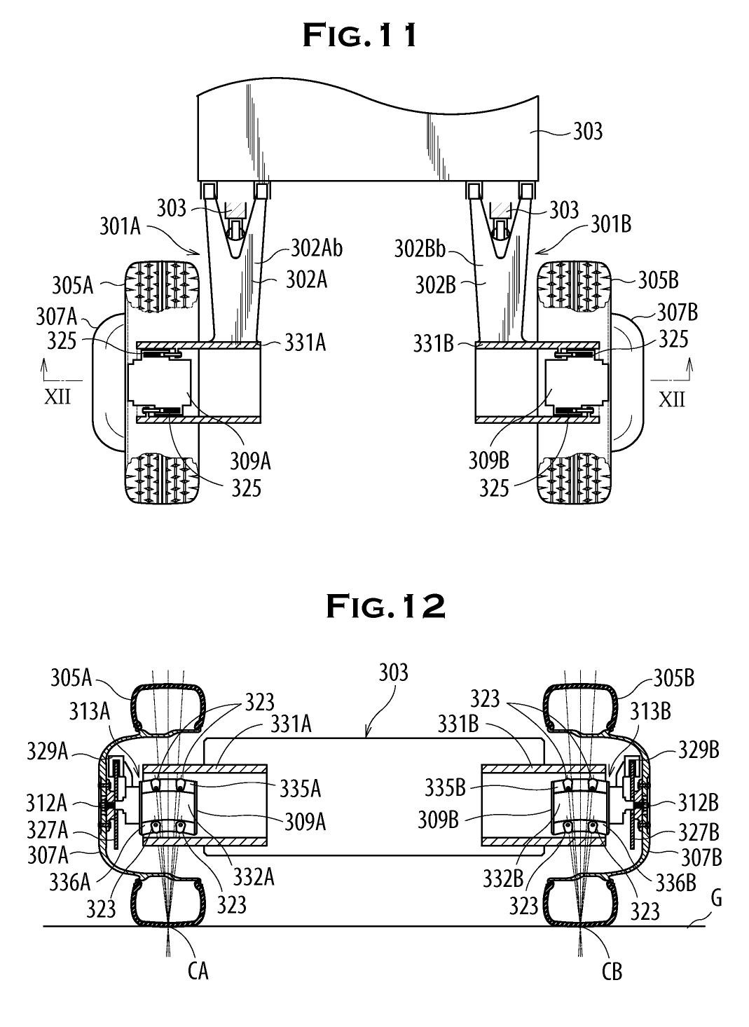

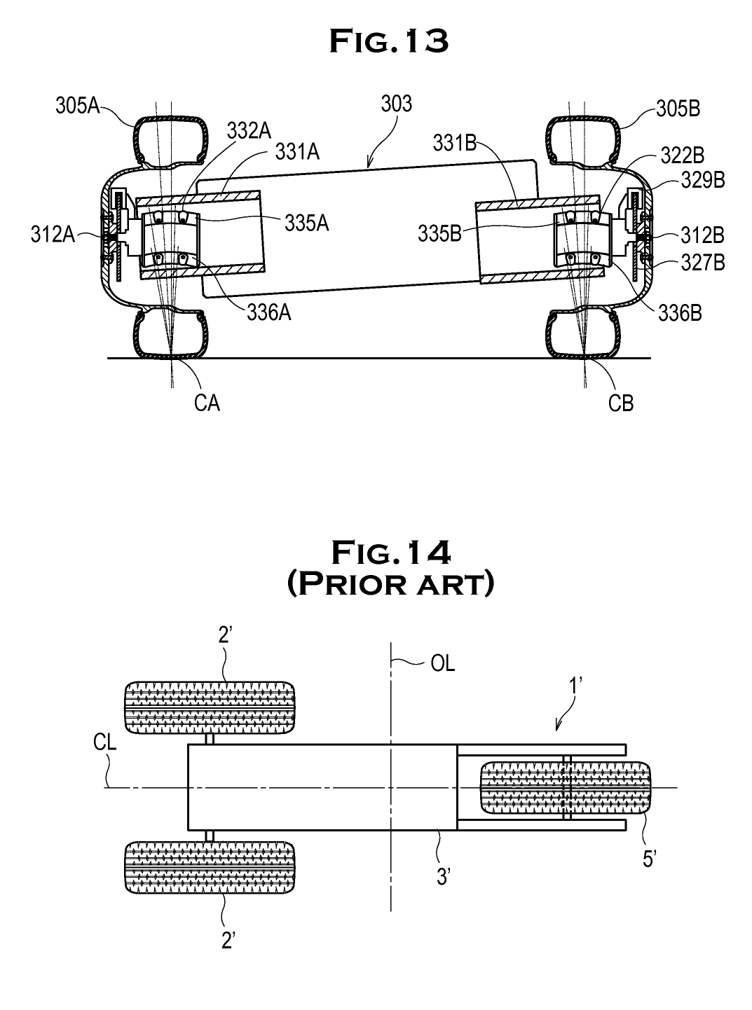

FIG. 11 is a plan view which is partially cut out, schematically illustrating suspension assemblies 301A and 301B according to a fifth embodiment of the present invention, which are used to support two rear wheels 305A and 305B, respectively, disposed in the rear of a vehicle body 303 of a vehicle. FIG. 12 is a sectional view of FIG. 11 as taken along line XII-XII. FIG. 13 is a sectional view illustrating motion of the suspension assemblies 301A and 301B during the vehicle cornering. In FIGS. 11 to 13, parts similar to the parts constituting the third embodiment illustrated in FIGS. 5 to 7 are denoted by reference numerals obtained by adding 200 to the reference numerals affixed to their counterparts in FIGS. 5 to 7. In addition, parts similar to the parts constituting the fourth embodiment illustrated in FIGS. 8 to 10 are denoted by reference numerals obtained by adding 100 to the reference numerals affixed to their counterparts in FIGS. 8 to 10 and descriptions are omitted. In FIGS. 11 to 13, hatching is omitted for better understanding and clarification of the figures in some portions which are supposed to be hatched.

The suspension assemblies 301A and 301B according to the embodiment include suspension mechanisms 302A and 302B and linkage mechanisms 313A and 313B, respectively. The suspension mechanisms 302A and 302B are configured to allow center-of-rotation shafts 312A and 312B of the rear wheels 305A and 305B to be displaced with respect to the vehicle body 303 in the vertical direction, respectively. The linkage mechanisms 313A and 313B link the suspension mechanisms 302A and 302B and the center-of-rotation shafts 312A and 312B, respectively, such that axes CA and CB of roll of vehicle body of the vehicle body 303 with respect to the rear wheels 305A and 305B are located in the vicinity of the contact ground surface G constantly or at all times and relative movement of the suspension mechanisms 302A and 302B with respect to the center-of-rotation shafts 312A and 312B is allowed, respectively.

In structure, the suspension mechanisms 302A and 302B according to the embodiment are single trailing-arm suspensions obtained by simplifying the suspension mechanism 102 illustrated in FIGS. 5 and 6. Outer cylindrical members 331A and 331B each constituting a movable member are mounted to ends of trailing arms 302Ab and 302Bb of the suspension mechanisms 302A and 302B, respectively. Inner cylindrical members 332A and 332B are disposed inside the outer cylindrical members 331A and 331B, respectively. The inner cylindrical members 332A and 332B are separately formed from the outer cylindrical members 331A and 331B, and each constitute a mounting member to be fitted to housings for motors 309A and 309B, respectively. In addition, eight rolling elements 323 constituting a rolling mechanism are rotatably mounted to the outer cylindrical members 331A and 331B. Four guide wall portions (guides) are integrally provided on the outer peripheral surfaces of the inner cylindrical members 332A and 332B at intervals in the circumferential direction. The guide wall portions extend in the radially outward direction and the axial direction of the center-of-rotation shafts 312A and 312B. In FIG. 12, only two paired guide wall portions (335A and 335B) and (336A and 336B), among the four guide wall portions (guides), are illustrated. As illustrated in FIG. 12, the guide wall portions 335A to 336B have an arcuate shape formed about the axes CA and CB of roll of the vehicle body. In the embodiment, the rolling elements 323 are rotatably mounted to the inner wall portions of the outer cylindrical members 331A and 331B such that two rolling elements 323 roll on each guide wall portion.

In the embodiment, as a result, as illustrated in FIG. 13, when a centrifugal force acts on the vehicle body 303 while the vehicle is traveling around a curve, the linkage mechanisms (331A and 331B, 332A and 332B, and 335A to 336B), which link the suspension mechanisms 302A and 302B for the wheels 305A and 305B and the center-of-rotation shafts 312A and 312B, allow motion of the suspension mechanisms 302A and 302B and the center-of-rotation shafts 312A and 312B, respectively, to maintain the ground camber angle (camber angle) at 0. Specifically, the rolling elements 323 move along the guide wall portions 335A to 336B, and the outer cylindrical members 331A and 331B are smoothly swung about the axes CA and CB of roll of the vehicle body with respect to the rear wheels 305A and 305B, respectively. As a result, the center-of-rotation shafts 312A and 312B are immovable with respect to the contact ground surface, and the suspension mechanisms 302A and 302B move with respect to the center-of-rotation shafts 312A and 312B to keep the wheels 305A and 305B and the road surface in contact with each other constantly or at all times even if the vehicle body 303 is tilted. In the embodiment, the axes CA and CB of roll of the vehicle body with respect to the rear wheels are located below the contact ground surface G in the vicinity of the contact ground surface G. Thus, the width of variation in angle (camber angle) of the wheels 305A and 305B with respect to the contact ground surface G is reduced even if the weight applied to the wheels 305A and 305B is varied.

The axes CA and CB of roll of the vehicle body with respect to the rear wheels 305A and 305B according to the embodiment will be described. As discussed above, for each single rear wheel 305A or 305B, the suspension mechanism 302A or 302B for the rear wheel 305A or 305B and the vehicle body 303 are considered as a single structure. The axis of the track of tilting motion of the structure with respect to the single rear wheel 305A or 305B as seen in a coordinate system that is stationary with respect to the rear wheel 305A or 305B corresponds to the axis CA or CB of roll of vehicle body with respect to the rear wheel 305A or 305B. The suspension mechanisms 302A and 302B are configured to allow the structure discussed above to make tilting motion about the axis CA or CB of roll of the vehicle body.

Also in the embodiment, the inner cylindrical members 332A and 332B constituting the mounting member of the linkage mechanism may be provided with at least one pair of guide wall portions (335A to 336B) each shaped in an arc centered around the axes CA and CB of roll of the vehicle body and vertically spaced (with a gap therebetween in the vertical direction), and the outer cylindrical members 331A and 331B may hold at least one pair of rolling mechanisms including one or more rolling elements 323 configured to roll along the at least one pair of guide wall portions (335A to 336B). Alternatively, the outer cylindrical members 331A and 331B constituting the movable member may be provided with at least one pair of guide wall portions (335A to 336B) each shaped in an arc centered around the axes CA and CB of roll of the vehicle body and vertically spaced (with a gap therebetween in the vertical direction), and the inner cylindrical members 332A and 332B may hold at least one pair of rolling mechanisms including one or more rolling elements 323 configured to roll along the at least one pair of guide wall portions (335A to 336B). If such a structure including the pair of guide wall portions and the one or more rolling elements 323 is used, the outer cylindrical members 331A and 331B can be smoothly swung about the axes CA and CB of roll of the vehicle body even if the rear wheels are composed of two wheels 305A and 305B.

Further, the outer cylindrical members 331A and 331B may be provided with one guide wall portion (guide) shaped in an arc centered around the axes CA and CB of roll of the vehicle body, and the inner cylindrical members 332A and 332B may hold a rolling mechanism including one or more rolling elements 323 configured to roll along the guide wall portion. Alternatively, the inner cylindrical members 332A and 332B may be provided with one guide wall portion (guide) shaped in an arc centered around the axes CA and CB of roll of the vehicle body, and the outer cylindrical members 331A and 331B may hold a rolling mechanism including one or more rolling elements 323 configured to roll along the guide wall portion.

Also in the embodiment, the suspension mechanisms 302A and 302B may each be configured to include an outer cylindrical member and a support frame as with the suspension mechanism 202 illustrated in FIGS. 8 to 10. If the suspension mechanisms 302A and 302B are each configured in the same manner as the suspension mechanism 202, the movable members including the outer cylindrical members can be smoothly swung about the axes of roll of the vehicle body.

### [Modification]

In each of the embodiments described above, the rolling elements 23, 123, 223, and 323 are used to reduce a contact resistance. As a matter of course, however, a stationary slider in which a portion corresponding to the rolling element 23, 123, 223, or 323 is formed from an adhesive material may be used to provide guiding only by sliding.

### INDUSTRIAL APPLICABILITY

With the suspension assembly according to the present invention, the suspension mechanism is relatively moved with respect to the center-of-rotation shaft when a centrifugal force acts on the vehicle body at a curve, which makes it possible to keep the rear wheel and the road surface in contact with each other constantly or at all times. In addition, if the axis of roll of vehicle body is set below the contact ground surface in the vicinity of the contact ground surface, the width of variation in angle (camber angle) of the rear wheel with respect to the contact ground surface can be advantageously reduced even if the weight applied to the rear wheel is varied.

While certain features of the invention have been described with reference to example embodiments, the description is not intended to be construed in a limiting sense. Various modifications of the example embodiments, as well as other embodiments of the invention, which are apparent to persons skilled in the art to which the invention pertains, are deemed to lie within the spirit and scope of the invention.

1. A suspension assembly for a vehicle including one or more front wheels and one or more rear wheels, wherein defining one side with respect to an orthogonal line orthogonal to a centerline of a vehicle as a front side and the other side with respect to the orthogonal line as a rear side, the one or more front wheels are provided on the front side and located on both sides with respect to the centerline of the vehicle and the one or more rear wheels are provided on the rear side, the suspension assembly operable for the one or more rear wheels and comprising:
a suspension mechanism configured to allow a center-of-rotation shaft for the one or more rear wheels to be displaced with respect to a vehicle body of the vehicle in a vertical direction; and
a linkage mechanism configured to link the suspension mechanism and the center-of-rotation shaft such that an axis of roll of the vehicle body with respect to the one or more rear wheels may constantly be located in the vicinity of a contact ground surface and relative movement of the suspension mechanism with respect to the center-of-rotation shaft is allowed.

2. The suspension assembly according to claim 1, wherein
the one or more rear wheels are composed of one wheel or double wheels sharing an axle.

3. The suspension assembly according to claim 1, wherein
the one or more rear wheels are composed of two wheels not sharing an axle.

4. The suspension assembly according to claim 1, wherein
the axis of roll of the vehicle body is located below the contact ground surface in the vicinity of the contact ground surface.

5. The suspension assembly according to claim 1, wherein:
a motor serving as a prime mover is housed inside one of the one or more rear wheels, the motor including a rotor fixed to a wheel member of the one rear wheel and a stator fixed to the center-of-rotation shaft;
both ends of the center-of-rotation shaft project from a motor case for the motor in a horizontal direction; and
the linkage mechanism includes:
a pair of mounting members fixed to the both ends of the center-of-rotation shaft; and
a pair of movable members configured to swing with respect to the pair of mounting members about the axis of roll of the vehicle body.

6. The suspension assembly according to claim 5,
wherein the suspension mechanism further includes a pair of arm portions configured to support the pair of movable members, at least one pair of guides each shaped in an arc centered around the axis of roll of the vehicle body and vertically spaced, and a pair of rolling mechanisms each including one or more rolling elements configured to roll along the at least one pair of guides; and
wherein the pair of guides are provided at the mounting members and the pair of rolling mechanisms are held by the movable members, or wherein the pair of guides are provided at the movable members and the pair of rolling mechanisms are held by the mounting members.

7. The suspension assembly according to claim 5,
wherein the suspension mechanism further includes a pair of arm portions configured to support the pair of movable members, a guide shaped in an arc centered around the axis of roll of the vehicle body, and a rolling mechanism including one or more rolling elements configured to roll along the guide; and
wherein the guide is provided at one of the pair of mounting members and the rolling mechanism is held by one of the pair of movable members, or wherein the guide is provided at one of the pair of movable members and the rolling mechanism is held by one of the pair of mounting members.

8. The suspension assembly according to claim 5, further comprising:
an origin return mechanism provided between the mounting members and the movable members and configured to return the movable members to an origin position with respect to the mounting members when the one or more rear wheels are positioned away from the contact ground surface.

9. The suspension assembly according to claim 2, wherein:
an inner-rotor motor serving as a prime mover is housed between two wheels constituting the double wheels;
both ends of a rotary motor shaft for the motor project from a motor housing in a horizontal direction and are coupled to wheel members of the two wheels, and the rotary motor shaft constitutes the center-of-rotation shaft; and
the linkage mechanism includes:
a mounting member provided at the motor housing; and
a movable member supported by the suspension mechanism and configured to swing with respect to the mounting member about the axis of roll of the vehicle body.

10. The suspension assembly according to claim 9, wherein:
the suspension mechanism further includes a support frame configured to support the movable member;
one of the mounting member and the movable member is provided with at least one pair of guides each shaped in an arc centered around the axis of roll of the vehicle body and vertically spaced;
the other of the mounting member and the movable member holds at least one pair of rolling mechanisms each including one or more rolling elements configured to roll along the at least one pair of guides.

11. The suspension assembly according to claim 9, wherein:
the suspension mechanism further includes a support frame configured to support the movable member;
one of the mounting member and the movable member is provided with a guide shaped in an arc centered around the axis of roll of the vehicle body; and
the other of the mounting member and the movable member holds a rolling mechanism including one or more rolling elements configured to roll along the guide.

12. The suspension assembly according to claim 9, further comprising:
an origin return mechanism provided between the mounting member and the movable member and configured to return the movable member to an origin position with respect to the mounting member when the one or more rear wheels are positioned away from the contact ground surface.

13. The suspension assembly according to claim 1, wherein:
the vehicle body is provided with a prime mover;
a wheel member of one of the one or more rear wheels is fixed to a rotary wheel shaft rotationally driven by the prime mover via a transfer mechanism and constituting the center-of-rotation shaft; and
the linkage mechanism includes:
a shaft bearing structure configured to rotatably support the rotary wheel shaft;
a mounting member in which the shaft bearing structure is housed; and
a movable member supported by the suspension mechanism and configured to swing with respect to the mounting member about the axis of roll of the vehicle body.

14. The suspension assembly according to claim 13, wherein:
the suspension mechanism further includes a support frame configured to support the movable member;
one of the mounting member and the movable member is provided with at least one pair of guides each shaped in an arc centered around the axis of roll of the vehicle body and vertically spaced; and
the other of the mounting member and the movable member holds at least one pair of rolling mechanisms each including one or more rolling elements configured to roll along the at least one pair of guides.

15. The suspension assembly according to claim 13, wherein:
the suspension mechanism further includes a support frame configured to support the movable member;
one of the mounting member and the movable member is provided with a guide shaped in an arc centered around the axis of roll of the vehicle body; and
the other of the mounting member and the movable member holds a rolling mechanism including one or more rolling elements configured to roll along the guide.

16. The suspension assembly according to claim 13, further comprising:
an origin return mechanism provided between the mounting member and the movable member and configured to return the movable member to an origin position with respect to the mounting member when the one or more rear wheels are positioned away from the contact ground surface.

17. The suspension assembly according to claim 13, further comprising:
a turning member disposed between the movable member and the support frame to turn over a predetermined angular range on the movable member.

18. A suspension assembly for a vehicle including one or more front wheels and one or more rear wheels, wherein:
defining one side with respect to an orthogonal line orthogonal to a centerline of a vehicle as a front side and the other side with respect to the orthogonal line as a rear side, the one or more front wheels are provided on the front side and located on both sides with respect to the centerline of the vehicle and the one or more rear wheels are provided on the rear side;
a motor serving as a prime mover is housed inside a wheel member of one of the one or more rear wheels;
a rotor of the motor is fixed to the wheel member;
a stator of the motor is fixed to a center-of-rotation shaft for the one or more rear wheels; and
the stator is provided with a pair of fixed shafts projecting in a lateral direction,
the suspension assembly operable for the one or more rear wheels and comprising:
a suspension mechanism configured to allow the center-of-rotation shaft for the one or more rear wheels to be displaced with respect to a vehicle body of the vehicle in a vertical direction; and
a linkage mechanism configured to link the suspension mechanism and the pair of fixed shafts such that an axis of roll of the vehicle body with respect to the one or more rear wheels may constantly be located in the vicinity of a contact ground surface and relative movement of the suspension mechanism with respect to the center-of-rotation shaft is allowed.

19. The suspension assembly according to claim 18, wherein
the linkage mechanism includes:
a pair of mounting members fixed to the pair of fixed shafts; and
a pair of movable members configured to swing with respect to the pair of mounting members about the axis of roll of the vehicle body.

20. The suspension assembly according to claim 19,
wherein the suspension mechanism further includes a pair of arm portions configured to support the pair of movable members, at least one pair of guides each shaped in an arc centered around the axis of roll of the vehicle body and vertically spaced, and a pair of rolling mechanisms each including one or more rolling elements configured to roll along the at least one pair of guides; and
wherein the pair of guides are provided at the mounting members and the pair of rolling mechanisms are held by the movable members, or wherein the pair of guides are provided at the movable members and the pair of rolling mechanisms are held by the mounting members.

21. The suspension assembly according to claim 19,
wherein the suspension mechanism further includes a pair of arm portions configured to support the pair of movable members, a guide shaped in an arc centered around the axis of roll of the vehicle body, and a rolling mechanism including one or more rolling elements configured to roll along the guide; and
wherein the guide is provided at one of the pair of mounting members and the rolling mechanism is held by one of the pair of movable members, or wherein the guide is provided at one of the pair of movable members and the rolling mechanism is held by one of the pair of mounting members.

22. The suspension assembly according to claim 19, further comprising:
an origin return mechanism provided between the mounting members and the movable members and configured to return the movable members to an origin position with respect to the mounting members when the one or more rear wheels are positioned away from the contact ground surface.

23. The suspension assembly according to claim 2, wherein
the axis of roll of the vehicle body is located below the contact ground surface in the vicinity of the contact ground surface.

24. The suspension assembly according to claim 3, wherein
the axis of roll of the vehicle body is located below the contact ground surface in the vicinity of the contact ground surface.
